(19) United States
(12) Patent Application Publication
(10) Pub. No.: US 2026/0151848 A1
(43) Pub. Date: Jun. 4, 2026

(54) LASER PROCESSING SYSTEM AND METHOD FOR PROCESSING A WORKPIECE

(71) Applicant: Precitec GmbH & Co. KG, Gaggenau (DE)

(72) Inventors: Bert SCHÜRMANN, Gernsbach (DE); Georg SPÖRL, Rheinstetten (DE)

(73) Assignee: Precitec GmbH & Co. KG, Gaggenau (DE)

(21) Appl. No.: 19/384,538

(22) Filed: Nov. 10, 2025

(30) Foreign Application Priority Data
Nov. 11, 2024 (DE) 10 2024 132 805.3

(51) Int. Cl. B23K 26/03; B23K 26/38

(52) U.S. Cl. CPC B23K 26/032; B23K 26/38

(57) ABSTRACT

A laser machining system for machining a workpiece by a laser beam. The laser machining system includes a laser machining head with at least one focusing optics for focusing the laser beam so that the workpiece is heated and process emission occurs; at least four optical sensors; and a control device. The optical sensors are insensitive to radiation having the wavelength of the laser beam and the optical sensors are each arranged to sense the process emission in at least one wavelength range that does not include the wavelength of the laser beam and to generate a respective sensor signal based thereon. The control device is configured to monitor the machining of the workpiece based on the mean value of the sensor signals.

### CROSS-REFERENCE TO RELATED APPLICATIONS

The present application claims priority of the German patent application 10 2024 132 805.3 filed Nov. 11, 2024, which is incorporated in its entirety by reference thereto.

### TECHNICAL FIELD

The present disclosure relates to a laser machining system and a method for machining a workpiece, in particular for piercing a workpiece and/or cutting a workpiece.

### BACKGROUND

In order to machine a workpiece, in particular to cut a workpiece, a laser beam is directed onto a surface of the workpiece. The laser beam heats an area of the workpiece to such an extent that part of the workpiece melts and/or vaporizes. If the workpiece is to be cut, the laser beam is directed onto an area of the workpiece until the workpiece is pierced, i.e., until a hole has formed in the workpiece through which the laser beam can pass. The laser beam is then moved along a path on the workpiece such that a cut is created. During machining, in particular due to the workpiece being heated, the workpiece emits process emissions. The process emissions may include radiation in the wavelength range visible to humans. The laser machining process may be monitored based on the process emissions.

DE 196 44 101 C1 relates to a method for beam penetration detection during the machining of a workpiece by means of a laser beam, wherein the intensity of radiation coming from the machining point is detected by at least one sensor and a status signal is generated when there is a predetermined change in intensity, wherein at least two mean values of the intensity of the detected radiation are each created at different time constants, and the status signal is generated when the mean values are in a predetermined ratio to each other.

The comparison of two measurement values at different points in time means that process monitoring can only take place with a time delay.

### SUMMARY

It is an object of the present disclosure to provide a laser machining system and a method by which process monitoring can be performed with a low time delay, in particular in real time or instantaneously. It is a further object of the present disclosure to provide a laser machining system and a method by which the accuracy of process monitoring can be improved. It is a further object of the present disclosure to provide a laser machining system and a method by which a structurally simple and/or space-saving option for monitoring a laser machining process using a laser beam with a laser machining wavelength of less than 1200 nm is made possible.

At least one of these objects is solved by the combination of features in the claims.

A laser machining system for machining a workpiece by a laser beam (also referred to as a machining laser beam) is disclosed. The laser machining system comprises a laser machining head with at least one focusing optics for focusing the laser beam onto a workpiece such that the workpiece is heated and process emission occurs. The laser machining system further comprises at least four optical sensors. The optical sensors are insensitive to radiation with the wavelength of said laser beam. The optical sensors are configured to sense the process emission in at least (or exactly) one wavelength range that does not include the wavelength of the laser beam and to generate a respective sensor signal based thereon. The laser machining system further comprises a control device. The control device is configured to monitor the machining of the workpiece based on a mean value of the sensor signals.

A method for machining, in particular for piercing and/or cutting, a workpiece by a laser beam is disclosed. The method comprises the steps of: radiating the laser beam onto the workpiece such that the workpiece heats up and process emission occurs; sensing the process emission by at least four optical sensors in at least (or exactly) one wavelength range that does not include the wavelength of the laser beam, and generating a respective sensor signal based thereon, wherein the optical sensors are insensitive to radiation with the wavelength of the laser beam; and monitoring the machining of the workpiece based on a mean value of the sensor signals. The monitoring may be performed by a control device. The monitoring may comprise performing closed-loop and/or open-loop control of the machining process based on the mean value.

Any method disclosed herein may be performed by any laser machining system disclosed herein. In particular, the control device may be configured to create the mean value of the sensor signals and/or to monitor the machining of the workpiece based on the mean value.

Any laser machining system disclosed herein may be used in any method disclosed herein.

According to the present disclosure, a mean value is created from the sensor signals of the optical sensors. This mean value may therefore also be referred to as a common mean value, i.e. the mean value may be taken from all sensor signals of the at least four optical sensors. The mean value may be created at a specific point in time, in particular instantaneously. By using a plurality of sensors that are insensitive to the laser wavelength and taking the mean value of the sensor signals, the machining process can be monitored with virtually no delay. This is particularly true when the signal-to-noise ratio is relatively low. The signal noise is often statistical, so that taking the mean value results in a smoother baseline and improves the signal-to-noise ratio. This improves the accuracy of the monitoring.

Moreover, the monitoring of a process with fiber lasers may also be enabled or improved. Fiber lasers typically have a laser wavelength of slightly above 1000 nm, particularly between 1070 nm and 1090 nm. Until now, sensors containing silicon (e.g., silicon photodiodes) have often been used for process monitoring. Such sensors have a wavelength sensitivity range of approximately 190 nm to 1100 nm. Silicon sensors are therefore sensitive to the wavelength of fiber lasers, and the measurement signal may contain a large proportion of the laser light.

The machining of the workpiece by the laser beam may be or comprise piercing, penetrating, and/or cutting the workpiece. The machining may also be welding or soldering. At least two workpieces may be welded together in this.

The workpiece may be a metallic workpiece or consist of metal or contain metal.

Process emission occurs due to the workpiece being heated by the laser beam. The process emission may comprise radiation in the wavelength range visible to humans, i.e., between 350 nm and 850 nm or between 390 nm and 850 nm or between 380 nm and 800 nm, e.g., radiation from a plasma generated during the machining. The process emission may include radiation in the infrared wavelength range, in particular thermal radiation. The process emission may include a component that has the wavelength of the laser radiation. This component of the process emission cannot be sensed by the optical sensors.

In addition, radiation from the laser beam may be backscattered or reflected back from the workpiece and enter the laser machining head. The backscattered or reflected radiation is not sensed by the optical sensors.

The process emission may radiate from the workpiece toward the laser machining head, in particular toward the at least four optical sensors. For example, the process emission may enter the laser machining head, in particular through an exit or nozzle opening for the laser beam in the direction of the workpiece.

The optical sensors (also referred to as photosensors or briefly as sensors herein) may be sensitive to a specific wavelength range or specific wavelength ranges. In particular, the sensors may be sensitive to at least one specific continuous or contiguous wavelength range. When radiation in this wavelength range or these wavelength ranges is incident on a light-sensitive surface of the sensors, a measurement signal may be generated.

The optical sensors are insensitive to the wavelength of the laser radiation. “Insensitive” may mean that radiation with a wavelength to which an optical sensor is insensitive is not or hardly sensed or that no or only a small measurement signal is generated when this radiation is incident on the optical sensor. The low measurement signal may be at least one order of magnitude (factor of 10), in embodiments, at least two orders of magnitude (factor of 100), lower than a measurement signal for radiation with a wavelength for which the sensor has the highest sensitivity. In other words, a measurement signal of a sensor for radiation with an insensitive wavelength may be at most 0.1, or at most 0.01, of a measurement signal of the sensor for radiation with a wavelength for which the sensor has the highest sensitivity.

Due to the insensitivity of the sensors to radiation with the wavelength of the laser beam, laser radiation scattered or reflected back from the workpiece and laser radiation diffusely scattered in the cutting head is suppressed by the sensors. In this way, it is possible to prevent the high intensity of laser radiation reflected or diffusely scattered in the cutting head from outshining the process emission with the wavelength of the laser beam and/or in wavelength ranges outside the wavelength of the laser beam.

Each of the four optical sensors may generate a measurement signal (also referred to as a sensor signal herein) when process emission is incident on a respective light-sensitive surface of the sensors (also referred to as a sensor surface). The four optical sensors may therefore generate four independent measurement signals. The optical sensors may be configured to sense the process emission simultaneously and/or to generate respective sensor signals simultaneously. The measurement signal or sensor signal may correspond to an intensity of the sensed process emission, in particular a temporal progression of the intensity. For example, the measurement signal or sensor signal of a respective sensor may correspond to the intensity of the process emission in the entire wavelength range or wavelength ranges in which the sensor is sensitive.

The sensor signals of the at least four optical sensors are averaged. In particular, signal values (also referred to as sensor values) of the sensor signals of the optical sensors that were sensed at the same time are used to create the mean value (or average value) of the sensor signals.

In order to create the mean value, the sensor signals or the signal values (also referred to as sensor values) of the sensor signals may be added together and divided by the number of added sensor signals or signal values. With four optical sensors, each generating a sensor signal, a total of four sensor values are obtained at one point in time. The mean value may be an arithmetic mean value.

The mean value may be created by connecting the sensors in parallel. In particular, all optical sensors may be connected in parallel. The sensors connected in parallel may generate a (summed) sensor signal. The (summed) sensor signal is to be understood as the mean value of the sensor signals. This allows for the mean value to be created without any subsequent arithmetic operations. The individual noise components may largely compensate each other in the (summed) sensor signal.

Alternatively, the control device may be configured to create the mean value of the sensor signals and to monitor the machining of the workpiece based on the mean value of the sensor signals.

By taking a mean value of the sensor signals from at least four optical sensors, it is possible to monitor the laser machining process even when the signal-to-noise ratio of the individual sensor signals is low.

In general, the monitoring of the machining of the workpiece may be performed by the control device. For this purpose, the mean value of the sensor signals may be compared with a threshold value. Depending on whether the mean value of the sensor signals is above or below the threshold value, the machining of the workpiece may be evaluated as “OK” or “not OK.” The laser machining system may be configured to output a message when the mean value of the sensor signals is below or above a threshold value.

Similarly, monitoring the machining of the workpiece may comprise comparing a sensor signal curve with a predetermined sensor signal curve. For this purpose, the sensor signal curve may be sensed and/or used over a defined period of time.

In embodiments, the laser machining system may comprise at least six optical sensors, at least eight optical sensors, at least ten optical sensors, at least fifteen optical sensors, at least twenty optical sensors, at least thirty optical sensors, at least forty optical sensors, or at least fifty optical sensors, or the sensors may be used in a method disclosed herein. A large number of sensors may improve the significance of the mean value and, even with low signal-to-noise ratios of the individual sensor signals, obtain a useful signal that can be easily evaluated. In addition, an increase in the number of sensors can in increase the total sensor area available.

The optical sensors may comprise or be optical semiconductor sensors. At least 50%, at least 70%, at least 90%, or all of the optical sensors may be optical semiconductor sensors. An optical semiconductor sensor may comprise at least one semiconductor material or element used to sense the radiation.

In embodiments, the optical semiconductor sensors are optical semiconductor compound sensors. A semiconductor compound sensor may comprise at least one semiconductor compound material used to sense the radiation. The semiconductor compound material may comprise at least two different elements or at least three different elements. The semiconductor compound material may be a binary or ternary material. The optical semiconductor compound sensors may be III-V semiconductor compound sensors or II-VI semiconductor compound sensors.

The semiconductor material of the optical sensors may comprise Ga (gallium). The semiconductor material of the optical sensors may comprise As (arsenic). The semiconductor material of the optical sensors may comprise P (phosphorus). In embodiments, the semiconductor material comprises Ga and As or Ga and P. In embodiments, the semiconductor material comprises Ga, As, and P. The optical semiconductor sensors may be GaAsP sensors.

None of the optical sensors may be a silicon sensor. In particular, none of the optical sensors may be an elemental semiconductor sensor. That is, none of the sensors may comprise silicon or an elemental semiconductor for sensing radiation.

All or a plurality of the optical sensors may be of the same type or identical. However, the optical sensors may be arranged at different positions. All or a plurality of the optical sensors may be constructed equally or of identical construction, i.e., for example, have sensor areas of the same size. All or a plurality of the optical sensors may have the same spectral sensitivity and/or be made of the same material.

The optical sensors may also comprise different types of sensors, i.e., for example, have different spectral sensitivities and/or be made of different materials. Different types of sensors may therefore differ in at least one of the following properties: spectral sensitivity; design or sensor area; and the material used to sense the radiation.

At least some of the optical sensors may be provided with an optical filter. The optical filter may transmit one or more wavelength ranges of the process emission and/or block one or more (other) wavelength ranges of the process emission. In this way, the optical sensors may be configured to sense process emission (completely or partially) in different wavelength ranges despite having identical spectral sensitivity.

In order to create the mean value, (only) sensor signals or sensor values of the optical sensors that have the same spectral sensitivity and/or are configured to sense process emission in the same wavelength range or wavelength ranges may be used. The control device may be configured to create a mean value for different wavelength ranges.

In embodiments, the optical sensors may each have a light-sensitive area (also referred to as a sensor area) of at least 0.01 mm², at least 0.02 mm², at least 0.03 mm², or at least 0.04 mm². In embodiments, the light-sensitive area of the optical sensors may respectively be at most 0.1 mm², at most 0.08 mm², or at most 0.06 mm². In embodiments, the light-sensitive area of the optical sensors is between 0.03 mm² and 0.05 mm². In this way, a compromise between sufficient signal strength (depending on the sensor area) and space requirements can be found.

In embodiments, the optical sensors may be insensitive in at least a wavelength range of more than 900 nm, or more than 800 nm. This means that the optical sensors may be insensitive to radiation with a wavelength of at least more than 900 nm or more than 800 nm. In embodiments, the optical sensors may be insensitive in a wavelength range of at least less than 550 nm, or less than 600 nm.

In embodiments, the optical sensors may be sensitive at least in a wavelength range between 100 nm and 900 nm, at least between 150 nm and 850 nm, at least between 200 nm and 800 nm, at least between 250 nm and 750 nm, at least between 250 nm and 700 nm, or at least between 300 nm and 680 nm.

The optical sensors may be sensitive in more than one wavelength range. For example, the optical sensors may comprise an optical filter by which a wavelength or wavelength range is excluded in which the optical sensors are insensitive.

In embodiments, the laser beam may have a wavelength between 950 nm and 1200 nm, between 1000 nm and 1150 nm, between 1000 nm and 1100 nm, or between 1025 nm and 1080 nm. In embodiments, the laser beam may have a wavelength between 500 nm and 550 nm or between 510 nm and 530 nm

The laser machining system may comprise a fiber laser, a high-power diode laser, or a disk laser for providing the laser beam.

In embodiments, the laser machining system does not comprise a CO₂ laser for providing the laser beam. The laser beam may therefore be provided by a laser other than a CO₂ laser.

The optical sensors may be sensitive to radiation with a wavelength shorter than the wavelength of the laser beam. In embodiment, between a maximum wavelength to which the optical sensors are sensitive and the wavelength of the laser beam, there may be a spectral distance of at least 10 nm, at least 25 nm, at least 50 nm, at least 75 nm, at least 100 nm, at least 150 nm, at least 200 nm, at least 250 nm, or at least 300 nm.

The optical sensors may be arranged in the laser machining head. The laser machining head may comprise a housing. The optical sensors may be arranged in the housing.

A plurality of optical elements for shaping and/or guiding the laser beam may be arranged in the laser machining head, in particular in the housing. For example, the laser machining head, in particular the housing, may include a laser coupler. The laser coupler may be connected to a laser (i.e., a laser source), for example via an optical fiber, and a laser beam may be coupled into the laser machining head or the housing from the laser source. A collimating optical system for collimating the laser beam divergently entering the laser machining head or the housing may be arranged in the laser machining head, in particular in the housing. The focusing optics, for example one or more focusing lenses, for focusing the laser beam onto the workpiece may be arranged in the laser machining head, in particular in the housing.

In embodiments, all optical sensors are arranged in the laser machining head, in particular in the housing. Alternatively, some of the sensors, e.g., at most 30%, at most 20%, or at most 10% of the sensors, may be arranged outside the laser machining head, in particular outside the housing, wherein the remaining sensors may be arranged inside the laser machining head, in particular inside the housing.

The optical sensors may be arranged in front of the focusing optics with respect to the direction of propagation of the laser beam. In particular, all optical sensors are arranged in front of the focusing optics with respect to the direction of propagation of the laser beam. The direction of propagation of the laser beam may be defined beginning from its entry into the laser machining head or the housing or beginning from the laser source in the direction of the workpiece. However, the present disclosure is not limited to an arrangement in front of the focusing optics. The optical sensors may also be arranged behind the focusing optics.

The optical sensors may be arranged, with respect to the direction of propagation of the laser beam, between the point of entry of the laser beam into the laser machining head and the point of exit of the laser beam from the laser machining head. In particular, the optical sensors are arranged between the fiber end and the last optical element, e.g., a protective glass, of the laser machining head with respect to the direction of propagation of the laser beam. The optical sensors may be arranged between the collimating optics and the focusing optics with respect to the direction of propagation of the laser beam.

Some of the optical sensors, e.g., at most 30%, at most 20%, or at most 10% of the optical sensors, may be arranged in front of the collimating optics and/or behind the focusing optics with respect to the direction of propagation of the laser beam.

The optical sensors may be arranged in a plane, for example in a plane perpendicular to the optical axis of the focusing optics. The optical sensors may be arranged at the same distance to the optical axis of the focusing optics. The optical sensors may be arranged symmetrically in the laser machining head, in particular in the housing of the laser machining head. The symmetry may relate to the optical path of the laser beam. Similarly, the symmetry may relate to the optical axis of the focusing optics. In particular, the optical sensors are arranged symmetrically about the optical axis of the focusing optics. In this way, monitoring may be provided independent of a machining direction.

A respective light-sensitive surface of the optical sensors may be oriented toward or face toward the workpiece or toward an exit opening of the laser machining head. Likewise, respective light-sensitive surfaces of the optical sensors may be oriented away from the direction of the workpiece or away from the direction of an exit opening of the laser machining head. The respective light-sensitive surfaces of the optical sensors may face away from the workpiece or an exit opening of the laser machining head. In this case, the process emission may enter the laser machining head and be reflected in the laser machining head, e.g., by an optical interface, onto the sensors.

In embodiments, all of the optical sensors are arranged outside the optical path of the laser beam. The optical path of the laser beam may be defined by optical elements in the laser machining head.

The laser machining system may comprise a sensor arrangement. The optical sensors, in particular all of the optical sensors, may be arranged on or in the sensor arrangement. The sensor arrangement may be arranged in the laser machining head, in particular in the housing of the laser machining head. The sensor arrangement may comprise a board or plate on which the optical sensors are arranged.

The sensor arrangement, in particular the board or plate, may be ring-shaped. The optical sensors may be arranged on the ring surface of the sensor arrangement. The ring surface may be flat. The optical sensors may be distributed evenly or regularly or irregularly along the ring surface. The sensor arrangement may be rotationally symmetrical. The sensor arrangement may be arranged coaxially with the optical axis of the focusing optics.

The sensor arrangement may have a recess. The recess may be formed substantially in the center of the sensor arrangement. The recess may be (completely) surrounded by the ring surface of the sensor arrangement. The sensor arrangement may be arranged in the laser machining head or in the housing of the laser machining head in such a way that the laser beam passes through the recess during the machining of the workpiece. The sensor arrangement may at least partially, in particular completely, surround the optical path of the laser beam.

In embodiment, the sensor arrangement may have an inner diameter of at least 5 mm, at least 10 mm, at least 20 mm, or at least 25 mm. In embodiments, the inner diameter of the sensor arrangement may be at most 150 mm, at most 100 mm, at most 50 mm, at most 40 mm, or at most 35 mm. The inner diameter of the sensor arrangement may correspond to a diameter of the recess.

The optical sensors may be arranged in a plane. The plane may be oriented substantially (±10° or ±5°) perpendicular to the optical axis of the focusing optics or to the optical path of the laser beam or to the direction of propagation of the laser beam.

All of the optical sensors may be arranged in the plane. Similarly, only some of the optical sensors, e.g., at least 50%, at least 60%, at least 70%, at least 80%, or at least 90% of the optical sensors, may be arranged in the plane. The remaining optical sensors may be arranged outside the plane.

At least two of the optical sensors may be arranged in a stack. In embodiments, at least four, at least ten, or at least fifteen, optical sensors are arranged in the stack.

The optical sensors may be arranged in the stack along an (imaginary) line. The line may extend substantially (±10° or ±5° or ±2°) in parallel to the optical axis of the laser beam. The optical axis may be defined by the collimating optics and/or the focusing optics.

The laser machining system may comprise a plurality of stacks with optical sensors. In embodiments, the laser machining system comprises at least two, at least three, at least four, or at least five stacks. Each of the stacks may be any stack disclosed herein.

The stacks may be arranged around the optical axis. In the circumferential direction around the optical axis, the stacks may be arranged in a uniform distribution. Likewise, the stacks may be arranged in a non-uniform distribution around the optical axis.

In general, the laser machining system may be configured to cut a workpiece using the laser beam. The laser machining process may be a laser cutting process.

The control device may be configured to determine a piercing time of the laser beam into the workpiece based on the signals from the optical sensors, in particular based on the mean value, to monitor a piercing process of the laser beam into the workpiece, to determine a quality of the machining of the workpiece, to detect a cutting error, to determine a quality of a cut edge of the workpiece, to detect a cut break, and/or to detect a cut interruption. Sensor signals from all optical sensors may be used to perform the aforementioned operations. In particular, the mean value may be created using all sensor signals, and the aforementioned operations may be performed based on the mean value.

In general, the laser machining process that may be performed in the laser machining system can be modified based on determining the piercing time of the laser beam into the workpiece, monitoring the laser beam's piercing process into the workpiece, determining the quality of the workpiece machining, and/or determining the quality of a cut edge of the workpiece. The modification of the laser machining process may be a closed-loop or open-loop control of the process.

By sensing the process emission using the optical sensors, the laser machining process can be monitored. In particular, the plurality of optical sensors, which filter out the diffusely scattered laser radiation or backscattered radiation of the machining laser in the cutting head, allow for fast and accurate monitoring of the laser machining process. The constructive implementation is relatively simple and compact.

### BRIEF DESCRIPTION OF THE DRAWINGS

Hereinafter, the present disclosure is described in detail with reference to figures.

FIG. 1 shows a laser machining system 100;

FIG. 2 shows some components of the laser machining system 100 schematically;

FIG. 3 shows a sensor arrangement 16;

FIG. 4a shows some components of the laser machining system 100 schematically in a side view; and

FIG. 4b shows some components of the laser machining system 100 schematically in a plan view.

### DETAILED DESCRIPTION

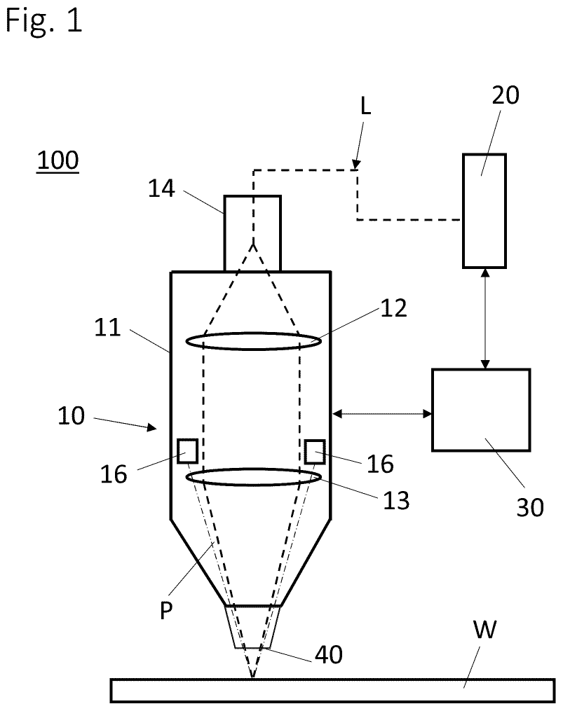

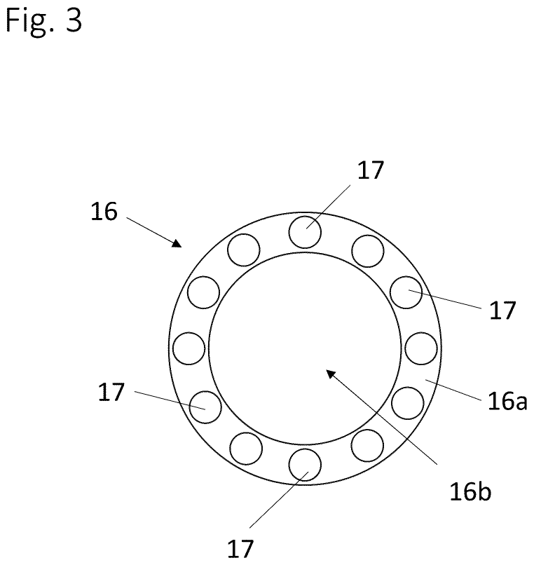

FIG. 1 shows a laser machining system 100. The laser machining system 100 may comprise a laser machining head 10, at least four optical sensors 17 (shown in more detail in FIG. 3), and a control device 30. The laser machining system 100 may further comprise a laser source 20.

The laser source 20 may generate a machining laser beam L (laser beam). The laser source 20 may be configured as a single-mode laser, a solid-state laser, a fiber laser, a high-power diode laser, or a disk laser. In embodiments, the laser source is not configured as a CO2 laser.

The machining laser beam L generated by the laser source 20 may be transmitted from the laser source 20 to the laser machining head 10 via an optical fiber. The machining laser beam L may be coupled into the laser machining head 10 via a fiber coupler 14. The fiber coupler 14 may be arranged at a housing 11 of the laser machining head 10.

The laser machining head 10 may comprise collimating optics 12 (collimation optics). The collimating optics 12 may be arranged in the laser machining head 10 and configured in such a way that the machining laser beam L divergently entering the laser machining head 10 is collimated. The collimating optics 12 may be arranged in the housing 11 of the laser machining head 10.

The collimating optics 12 may comprise at least one lens or two or more lenses. A distance between the two or more lenses may be adjustable, in particular by an electric motor. The collimating optics 12 may define an optical axis.

Furthermore, the laser machining system 100 may comprise focusing optics 13. The focusing optics 13 may be arranged in the laser machining head 10 in such a way that the collimated machining laser beam L is focused. The focusing optics 13 may be arranged in the housing 11 of the laser machining head 10.

The focusing optics 13 may comprise at least one lens or two or more lenses. A distance between the two or more lenses may be adjustable, in particular by an electric motor. An optical axis may be defined by the focusing optics 13. The focusing optics 13 may be an F-theta lens.

The focused machining laser beam L may be radiated from the laser machining head 10 and radiated onto a workpiece W in order to machine the workpiece W.

The laser machining head 10 may have an exit opening 40. The laser beam may exit the laser machining head 10 from the exit opening 40 and be directed toward the workpiece W. The exit opening 40 may be formed in a nozzle arranged at one end of the laser machining head 10, in particular at one end of the housing 11 of the laser machining head 10.

For example, the workpiece W may be cut. For this, the laser beam L may be radiated onto a surface of the workpiece W until an area of the workpiece W melts and/or vaporizes. The laser beam L may be radiated onto the area of the workpiece W until the workpiece W is penetrated (so-called piercing into the workpiece). This may form a hole in the workpiece W through which the laser beam L can pass. The laser beam L may then be moved along a machining path to form a cut in the workpiece W. The workpiece W may also be welded or soldered. In particular, two workpieces W may be welded or soldered together.

The laser machining head 10 may be a laser beam cutting head, a laser beam welding head, or a laser beam soldering head.

The workpiece W may emit process emission P. The process emission P may comprise radiation in different wavelength ranges, e.g., in the wavelength range visible to humans, in the infrared wavelength range, in the ultraviolet wavelength range, and in the wavelength range of the laser beam L. The process emission P may radiate into the laser machining head 10 starting from the workpiece W, in particular via the exit opening 40.

The at least four optical sensors 17 may be arranged in the laser machining head 10. The optical sensors 17 are insensitive to radiation with the wavelength of the laser beam L, so that reflected laser radiation L is not detected by the optical sensors 17. Nevertheless, the optical sensors 17 are configured to detect process emission P. For this purpose, the optical sensors 17 have spectral sensitivity in at least the visible wavelength range, i.e., between 350 nm and 780 nm. In embodiments, the optical sensors 17 are insensitive in a wavelength range of more than 900 nm. Below a wavelength of 900 nm, the optical sensors 17 may at least in parts or areas be sensitive to radiation, in particular the process emission P.

The optical sensors 17 sense the process emission P in a wavelength range or in wavelength ranges that do not include the wavelength of the laser beam L and generate a sensor signal (measurement signal). Each of the optical sensors 17 may generate a sensor signal.

The sensor signals of the optical sensors 17 at a specific point in time may be averaged by the control device 30 in order to create a mean value of the sensor signals.

Similarly, the sensors 17 may be connected in parallel. Due to the parallel connection, a (summed) sensor signal can be generated by the sensors 17. The (summed) sensor signal may correspond to the mean value of the sensor signals.

The laser machining process may be monitored based on the mean value. In particular, a piercing time of the laser beam into the workpiece W may be determined, the piercing process of the laser beam L into the workpiece W may be monitored, a quality of the machining of the workpiece W may be determined, and/or a quality of a cut edge or the cut edges of the workpiece W may be determined. The piercing process and the cutting process may proceed differently for different workpieces W or different areas on a workpiece W. For example, the piercing process may be completed more quickly when the area of the workpiece W is “warm” compared to a “cold” area of the workpiece W. If another piercing process or cutting process has already been performed close to the area of the workpiece W in which a piercing process is to be performed, the area of the workpiece W may already have an elevated temperature and the piercing process may be shortened.

Closed-loop or open-loop control of the laser machining process may be performed based on the monitoring. For example, the laser beam L may be moved along the machining path to form the cut as soon as the piercing process is complete. For this purpose, it is helpful to know without large time delay when the piercing process is complete. Taking the mean value allows for quick monitoring of the laser machining process, so that the laser machining process can be improved.

The optical sensors 17 may be arranged in the laser machining head 10 in front of the focusing optics 13 with respect to the direction of propagation of the laser beam L. In embodiments, the optical sensors 17 are arranged in the laser machining head 10 in front of the focusing optics 13 and behind the collimating optics 12 with respect to the direction of propagation of the laser beam L. It is also possible for the optical sensors 17 to be arranged in the laser machining head 10 behind the focusing optics 13 or in front of the collimating optics 12 with respect to the direction of propagation of the laser beam L. In embodiments, all of the optical sensors 17 may be arranged in the laser machining head 10.

The optical sensors 17 may be arranged in a plane. The plane may be oriented substantially perpendicular to the optical axis of the focusing optics 13 and/or to the optical axis of the collimating optics 12.

A respective light-sensitive surface of the optical sensors 17 may be oriented or face toward the workpiece W and/or toward the exit opening 40, i.e., the light-sensitive surfaces of the optical sensors 17 may be opposite the workpiece W and/or the exit opening 40 or face these. Similarly, the light-sensitive surfaces of the optical sensors 17 may face the entry point, for example the fiber coupler 14. The respective light-sensitive surfaces of the optical sensors 17 may be arranged substantially (±10° or ±5°) perpendicular to the optical axis of the focusing optics 13.

The laser machining system 100 may comprise a sensor arrangement 16. The optical sensors 17, in embodiments all of the optical sensors 17, may be arranged in or on the sensor arrangement 16. The sensor arrangement 16 is optional. The laser machining system 100 may also comprise the optical sensors 17 without the sensor arrangement 16. For example, the optical sensors 17 may be arranged individually or in groups on the housing 11 of the laser machining head 10.

The sensor arrangement 16 may be arranged in the laser machining head 10, in particular in the housing 11 of the laser machining head 10. In embodiments, the sensor arrangement 16 is positioned in front of the focusing optics 13 with respect to the propagation direction of the laser beam L. The sensor arrangement 16 may be arranged between the collimating optics 12 and the focusing optics 13.

Furthermore, the laser machining head 10 may comprise a lens, a transmissive element, a reflective element, a radiation shaping element, a beam splitter, and/or an optical wedge.

Optical elements of the laser machining head 10 may define an optical path for the machining laser beam L through the laser machining head 10.

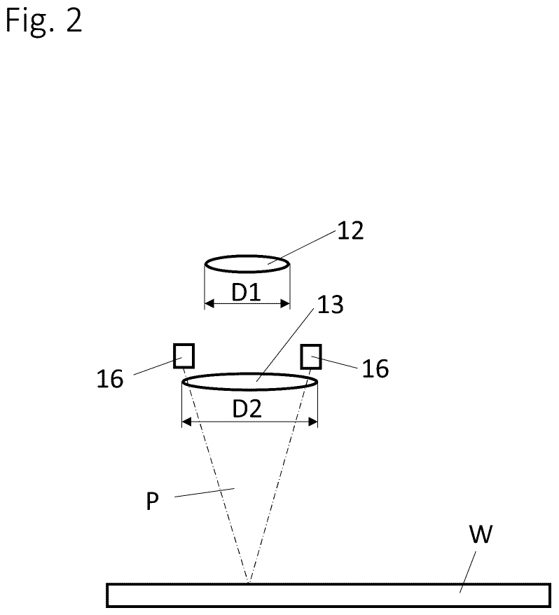

FIG. 2 shows some components of the laser machining system 100 in a schematic view. The collimating optics 12, the focusing optics 13, and the optional sensor arrangement 16 with the optical sensors 17 (not shown in FIG. 2) are shown. The laser machining system 100 may comprise or have some or all of the components and/or features disclosed herein.

The optical sensors 17, which are arranged, for example, in or on the sensor assembly 16, may be arranged in front of the focusing optics 13 with respect to the direction of propagation of the laser beam L. Process emission P emitted from the workpiece W may enter the laser machining head 10, pass through the focusing optics 13, and strike the optical sensors 17.

The diameter D2 of the focusing optics 13 may be larger than the diameter D1 of the collimating optics 12. In particular, the outer diameter of the focusing optics 13 may be larger than the outer diameter of the collimating optics 12. This allows for the optical sensors 17 or the sensor arrangement 16 to be arranged outside the beam path of the laser beam L and the beam path of process emission P entering the laser machining head 10 to be guided through the focusing optics 13.

FIG. 3 shows an embodiment of the sensor arrangement 16. The sensor arrangement 16 comprises the optical sensors 17 (in FIG. 3, only some of the sensors 17 are provided with a reference symbol).

All optical sensors 17 or some of the optical sensors 17 may be arranged on or in the sensor arrangement 16.

The sensor arrangement 16 may have any shape and may be arranged arbitrarily in the laser machining head 10 or in the housing 11 of the laser machining head 10. In the example shown in FIG. 3, the sensor arrangement 16 is ring-shaped. The optical sensors 17 may be arranged on the ring surface 16a of the sensor arrangement 16. The optical sensors 17 may be arranged on the sensor arrangement 16 in a uniform or non-uniform distribution.

The sensor arrangement 16 may have a recess 16b. The recess 16b may be formed substantially in the center of the sensor arrangement 16. The ring surface 16a may at least partially, in particular completely, surround or enclose the recess 16b. The sensor arrangement 16 may be arranged in the laser machining head 10 in such a way that the laser beam L can radiate through the recess 16b. In embodiments, the ring surface 16a surrounds the optical path of the laser beam L when the sensor arrangement 16 is arranged in the laser machining head 10.

The optical sensors 17 may have light-sensitive surfaces. When radiation with a wavelength (detectable wavelength range or detectable wavelength ranges) detectable by the optical sensors 17 is incident on the light-sensitive surfaces, the optical sensors 17 may generate a measurement signal or a sensor signal.

The light-sensitive surfaces of the optical sensors 17 may face the workpiece W. Similarly, the light-sensitive surfaces of the optical sensors 17 may face the exit opening 40. The light-sensitive surfaces of the optical sensors 17 may be arranged substantially (±10° or ±5°) perpendicular to the optical axis of the focusing optics 13 or to the optical axis of the collimating optics 12 in the laser machining head 10.

Due to the arrangement of the optical sensors 17 in the laser machining head 10, no additional deflection mirrors for coupling the process emission P out of the beam path of the process emission P are necessary. Likewise, no additional beam splitter for coupling the process emission P out of the beam path is necessary. This also allows for a compact design of the laser machining head 10 or the laser machining system 100 to be achieved.

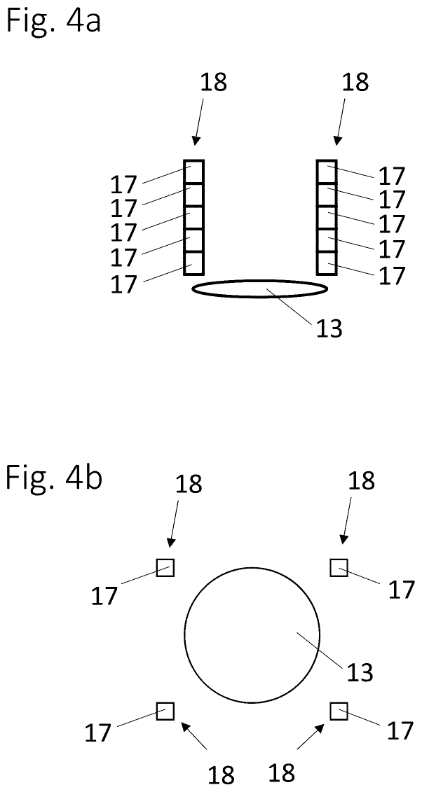

FIG. 4a schematically shows some components of a laser machining system 100. The laser machining system 100 may be any laser machining system disclosed herein, wherein identical components are not described again. The view of FIG. 4a is a schematic side view.

The laser machining system 100 comprises the at least four optical sensors 17 already described. At least two of the optical sensors 17 may be arranged in a stack 18. In embodiments, at least four, at least ten, or at least fifteen optical sensors 17 are arranged in the stack 18. The optical sensors 17 may be arranged in the stack 18 along a (virtual) line. The line may extend substantially (±10° or ±5° or ±2°) in parallel to the optical axis of the laser beam L. The optical axis may be defined by the collimating optics 12 and/or the focusing optics 13.

The stack 18 may be arranged completely within the laser machining head 10, in particular completely within the housing 11 of the laser machining head 10. The stack 18 may be arranged completely (along the optical axis of the laser beam L) between the collimating optics 12 and the focusing optics 13.

The optical sensors 17 of the stack 18 may (all) be in contact with each other. Similarly, the optical sensors 17 of the stack 18 may (all) be spaced apart from each other.

FIG. 4b shows the components of the laser machining system 100 of FIG. 4a in a schematic top view.

The laser machining system 100 may comprise a plurality of stacks 18 with optical sensors 17. In embodiments, the laser machining system 100 comprises at least two, at least three, at least four, or at least five stacks 18. Each of the stacks 18 may be any stack 18 disclosed herein. All stacks 18 may each comprise the same number of optical sensors 17. The optical sensors 17 may be arranged identically in all stacks 18. Similarly, the stacks 18 may comprise a different number of optical sensors 17 and/or the optical sensors 17 may be arranged differently in the stacks 18.

The stacks 18 may be arranged around the optical axis. In the circumferential direction around the optical axis, the stacks 18 may be arranged in a uniform distribution. When the laser machining system 100 comprises, for example, four stacks 18 with optical sensors 17, one stack 18 may be arranged every 90° in the circumferential direction around the optical axis. Similarly, the stacks 18 may be arranged around the optical axis in a non-uniform distribution.

1. A laser machining system for machining a workpiece by a laser beam, the laser machining system comprising:
a laser machining head with at least one focusing optics for focusing the laser beam so that the workpiece is heated and process emission occurs;
at least four optical sensors, wherein the optical sensors are insensitive to radiation having a wavelength of the laser beam and wherein the optical sensors are each configured to sense the process emission in at least one wavelength range that does not include the wavelength of the laser beam and to generate a respective sensor signal based thereon; and
a control device configured to monitor the machining of the workpiece based on a mean value of the sensor signals.

2. The laser machining system according to claim 1, comprising at least six optical sensors.

3. The laser machining system according to claim 1, wherein the optical sensors comprise semiconductor sensors.

4. The laser machining system according to claim 3, wherein the semiconductor sensors are at least one of semiconductor compound sensors and GaAsP sensors.

5. The laser machining system according to claim 1, wherein the optical sensors are of a same type.

6. The laser machining system according to claim 1, wherein the optical sensors comprise at least two different types of sensors.

7. The laser machining system according to claim 1, wherein the optical sensors are insensitive at least in a wavelength range of more than 900 nm.

8. The laser machining system according to claim 1, wherein the wavelength of the laser beam is between 950 nm and 1200 nm.

9. The laser machining system according to claim 1, wherein the laser machining head comprises a housing and the optical sensors are arranged in the housing.

10. The laser machining system according to claim 1, wherein the optical sensors are arranged in front of the at least one focusing optics with respect to a direction of propagation of the laser beam.

11. The laser machining system according to claim 1, wherein the optical sensors are arranged outside an optical path of the laser beam.

12. The laser machining system according to claim 1, wherein the optical sensors are arranged in a plane perpendicular to an optical axis of the at least one focusing optics.

13. The laser machining system according to claim 1, wherein the optical sensors are arranged symmetrically with respect to an optical axis of the at least one focusing optics.

14. The laser machining system according to claim 1, further comprising a ring-shaped sensor arrangement, wherein the optical sensors are arranged on a ring surface of the ring-shaped sensor arrangement.

15. The laser machining system according to claim 14, wherein the ring-shaped sensor arrangement is arranged coaxially with an optical axis of the at least one focusing optics.

16. The laser machining system according to claim 1, wherein at least two of the optical sensors, are arranged in a stack, wherein the optical sensors are arranged along a line.

17. The laser machining system according to claim 1, wherein the laser machining system is configured to pierce the workpiece by the laser beam and/or to cut the workpiece by the laser beam.

18. The laser machining system according to claim 14, wherein the control device is configured to:
determine a piercing time of the laser beam into the workpiece based on the mean value,
monitor a piercing process of the laser beam into the workpiece,
determine a quality of the machining of the workpiece,
determine a quality of a cut edge of the workpiece, and/or
perform closed-loop control of the machining of the workpiece.

19. The laser machining system according to claim 1, wherein the optical sensors are connected in parallel, and
wherein the mean value of the sensor signals is a sensor signal obtained by a parallel connection of the optical sensors.

20. A method of machining a workpiece by a laser beam, the method comprising:
radiating the laser beam onto the workpiece so that the workpiece heats up and process emission occurs;
sensing the process emission using at least four optical sensors in at least one wavelength range that does not include a wavelength of the laser beam and, based thereon, generating a respective sensor signal, the optical sensors are insensitive to radiation with the wavelength of the laser beam; and
monitoring the machining of the workpiece, by a control device, based on a mean value of the sensor signals.
